(19) United States
(12) Patent Application Publication
(10) Pub. No.: US 2010/0149475 A1
(43) Pub. Date: Jun. 17, 2010

(54) LIQUID CRYSTAL DISPLAY DEVICE HAVING IMPROVED ALIGNMENT OF LIQUID CRYSTALS

(76) Inventors: Hee-Seop Kim, Hwaseong-si (KR); Joo-Nyung Jang, Gyeongsan-si (KR); Hwa-Sung Woo, Suwon-si (KR); Hyang-Yul Kim, Hwaseong-si (KR); Cheol Shin, Hwaseong-si (KR); Dong-Chul Shin, Seoul (KR)

Correspondence Address: HAYNES AND BOONE, LLP;IP Section, 2323 Victory Avenue, Suite 700, Dallas, TX, 75219, US

(21) Appl. No.: 12/484,724

(22) Filed: Jun. 15, 2009

(30) Foreign Application Priority Data
Dec. 11, 2008 (KR) 10-2008-0126063

(51) Int. Cl. G02F 1/1337; G02F 1/13

(52) U.S. Cl. 349/123; 349/187

(57) ABSTRACT

A liquid crystal display device provides for improved alignment of its liquid crystal molecules by having an alignment layer with polymer branches that are cured so as to reinforce a predefined orientation of the liquid crystal molecules even when no voltages are applied to the pixel-electrodes and/or common electrode of the device. Bruising of the screen can thus be rapidly repaired. In one embodiment, the device includes: first and second substrates opposed to each other; a liquid crystal layer including liquid crystal molecules interposed between the substrates; a gate line formed on the first substrate; first and second data lines formed on the first substrate and connected for transmitting first and second data voltages having different polarities; a first and second switching elements respectively connected to the gate line and the first or second data line; first and second pixel electrodes that are connected to the first and second switching elements, respectively; an alignment layer formed on the first and second pixel electrodes; and a polymer layer including a plurality of cured prepolymers that are cured so as to prearrange the liquid crystal molecules in a desired orientation.

### CROSS-REFERENCE TO RELATED APPLICATION

This application claims priority to and the benefit of Korean Patent Application No. 10-2008-0126063 filed in the Korean Intellectual Property Office on Dec. 11, 2008, the entire contents of which are incorporated herein by reference.

### BACKGROUND OF THE INVENTION

(a) Field of Invention

The present disclosure of the invention relates to a liquid crystal display device.

(b) Description of Related Technology

A liquid crystal display device (LCDD) is one of commonly used flat panel display devices. The liquid crystal display device typically includes two spaced apart display panels where one of these typically has pixel electrodes formed thereon and the other has one or more common electrodes formed thereon and a liquid crystal layer is interposed between the two display panels. An electric field is generated through the liquid crystal layer by applying a voltage between each pixel-electrode and its portion of the common electrode to thereby locally determine the alignment of liquid crystal molecules in the liquid crystal layer and thus control the polarization of passing through light, thereby ultimately causing display of a desired image.

To improve quality of the liquid crystal display device, it is desired for the liquid crystal display device to have a high contrast ratio, a wide viewing angle and fast response time.

Also, it is desirable to prevent deterioration of image quality due to bruising caused by disorder of the alignment of the liquid crystal molecules in a circumstance of outside changes such as application of external pressure to the panel.

The above information disclosed in this Related Technology section is only for enhancement of understanding of the background of this invention disclosure and therefore it may contain information that does not form the prior art that was already known to persons of ordinary skill in the art.

### SUMMARY

The present disclosure of the invention relates to a liquid crystal display device, more specifically to provision of a liquid crystal display device (LCDD) having high contrast ratio, a wide viewing angle and fast response time as well as good image quality even if subject to bruising which may otherwise cause disorder of the alignment of the liquid crystal molecules in a circumstance of outside perturbation such as application of external pressure to the display panel.

A liquid crystal display device according to an embodiment of the present disclosure comprises; first and second substrates opposed to each other; a liquid crystal layer including liquid crystal molecules interposed between the first and second substrates; a plurality of gate lines formed on the first substrate and used for transmitting respective gate signals; first and second data lines formed on the first substrate and respectively used for transmitting first and second data voltages having different polarities relative to a predefined reference voltage; in each pixel unit, a first switching element connected to the respective gate line and to the first data line associated with that pixel unit; in each pixel unit, a second switching element connected to the respective gate line and the second data line associated with that pixel unit; in each pixel unit, first and second pixel electrodes that are connected to the respective first and second switching elements, and the first and second pixel electrodes being separated from each other; first and second alignment layers respectively formed on the first and second substrates including over the first and second pixel electrodes of each pixel unit; and first and second polymer layers respectively formed on the first and second substrates and each having dangling bonds oriented for prearranging the liquid crystal molecules according to predefined tilt angles when a orienting voltage is not present. In one embodiment, the dangling bonds are oriented for aligning adjacent liquid crystal molecules substantially vertically relative to major horizontal surfaces of the first and second substrates.

The pre-oriented dangling bonds of the polymer layers may be so disposed by applying a polymerizing light (e.g., UV light) during manufacture to a plurality of the prepolymers provided in the liquid crystal layer where the prepolymers (polymer precursors) are provided in a mixture including the liquid crystal molecules and the prepolymers are curable by (capable of being polymerized by) the applied light.

In one embodiment, the prepolymers may be contained in the liquid crystal layer in an amount between about 0.01 weight percent (wt %) to about 3 weight percent (wt %) based on the liquid crystal molecules.

The prepolymers may be contained in the liquid crystal layer in an amount specifically between about 0.01 weight percent (wt %) to about 0.5 weight percent (wt %) based on the liquid crystal molecules.

Energy levels of the polymerizing light applied toward the liquid crystal layer during manufacture may be between about 3 joule (“J”) to about 20 J per unit area.

Distances between adjacent branch electrodes of the first pixel electrode and the second pixel electrode may be uniform with respect to their position.

Polarities of the first and the second data voltages may be opposite to each other in the case where Vcom is zero volts.

The first and second pixel-electrodes may be formed as interdigitated branch electrodes that are obliquely inclined with respect to the gate line.

The first and second pixel electrodes may be formed in a same layer.

The liquid crystal display device further may comprise a common electrode that is formed on the second substrate and applied with a common voltage, Vcom.

### BRIEF DESCRIPTION OF THE DRAWINGS

FIG. 1 is a block diagram of a liquid crystal display device according to an exemplary embodiment of the present disclosure;

FIG. 2 is an equivalent circuit diagram of a structure of a liquid crystal display device and one pixel according to an embodiment;

FIG. 3 is an equivalent circuit diagram illustrating one pixel of a liquid crystal display device according to an embodiment;

FIG. 4 is a schematic cross-sectional view of a liquid crystal display device according to an embodiment;

FIG. 5 is a diagram illustrating voltages of data lines and pixels of a liquid crystal display device according to an embodiment;

FIG. 6 is a layout view of a liquid crystal panel assembly according to an embodiment;

FIG. 7 is a cross-sectional view of the liquid crystal panel assembly taken along line XII-XII of FIG. 6;

FIG. 8 is a diagram illustrating mechanism of strongly vertically prearranged liquid crystal molecules by curing prepolymers by irradiating light such as ultraviolet (“UV”) on the display panel;

FIG. 9 is a diagram illustrating the pixel electrode and a texture region of a liquid crystal display device according to an embodiment;

FIG. 10 is photographs the pixel electrode and portion of a texture region of a liquid crystal display device according to an embodiment;

FIG. 11 is a schematic cross-sectional view of a liquid crystal display device according to an embodiment; and

FIG. 12 is a graph illustrating restoring force of the liquid crystal molecules restoring to their initial arrangement by a formed polymer layer according to an embodiment.

### DETAILED DESCRIPTION

The present disclosure will be more fully developed hereinafter with reference to the accompanying drawings, in which exemplary embodiments are shown. As those skilled in the art would realize after appreciating this disclosure, the described embodiments may be modified in various different ways, all without departing from the spirit or scope of the present disclosure.

In the drawings, the thickness of layers, films, panels, regions, etc., may be exaggerated for clarity. Like reference numerals typically designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

Hereinafter, a liquid crystal display device according to a first embodiment will be described in detail with reference to the accompanying drawings.

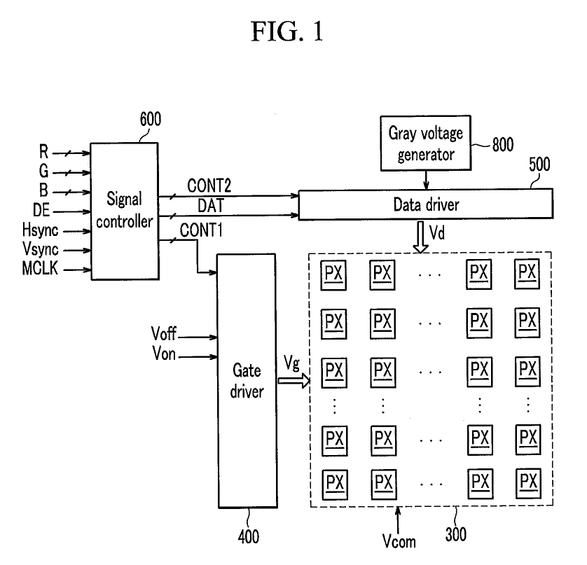

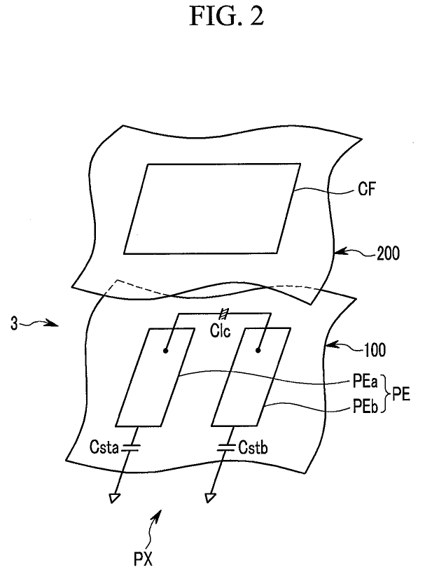

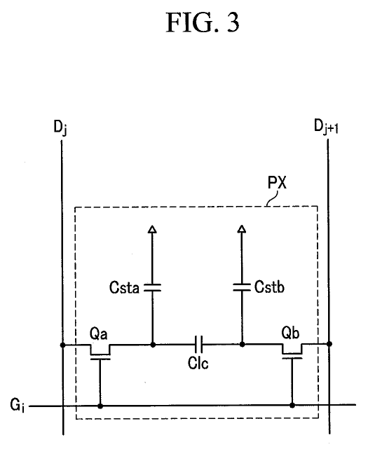

FIG. 1 is a block diagram of a liquid crystal display device according to the first embodiment, FIG. 2 is an equivalent circuit diagram illustrating a structure of one pixel in a liquid crystal display device according to an embodiment and, and FIG. 3 is an equivalent circuit diagram illustrating the one pixel of a liquid crystal display device according to the embodiment.

Referring to FIG. 1, a liquid crystal display device according to an embodiment includes a liquid crystal panel assembly 300, a gate driver 400, a data driver 500, a gray voltage generator 800, and a signal controller 600.

Referring to FIG. 1 and FIG. 3, the liquid crystal panel assembly 300 includes a plurality of gate and data signal lines Gᵢ, Dⱼ, and Dⱼ₊₁ and a plurality of pixel units PX that are connected thereto and arranged substantially in a matrix. In contrast, in view of a structure shown in FIG. 2, the liquid crystal panel assembly 300 includes upper and lower panels, 100 and 200 respectively, that are opposed to each other, and a liquid crystal layer 3 interposed therebetween.

The signal lines Gᵢ, Dⱼ, and Dⱼ₊₁ include a plurality of gate lines Gᵢ transmitting a gate signal (also referred to as “a scanning signal”) and a plurality of pairs of data lines Dⱼ and Dⱼ₊₁ each transmitting a respective data voltage. The gate lines Gi extend substantially in a row direction and are substantially parallel to each other. The data lines Dⱼ and Dⱼ₊₁ extend substantially in a column direction and are substantially parallel to each other.

Each pixel unit PX, for example a pixel PXᵢⱼ that is connected to the i-th (i=1, 2, . . . n) gate line Gᵢ and the j-th and (j+1)-th (j=1, 2, . . . , m) data lines, Dⱼ and Dⱼ₊₁ includes first and second switching devices Qa and Qb connected to the signal lines Gᵢ, Dⱼ, and Dⱼ₊₁, a first liquid crystal capacitor Clc formed between respective pixel-electrodes PEa and PEb, and first and second storage capacitors Csta and Cstb coupled to respective pixel-electrodes PEa and PEb. The first and second storage capacitors Csta and Cstb may be omitted if desired. While not explicitly shown in FIG. 2, in one embodiment, a common electrode is formed on the upper panel 200 so as to thereby define second and third liquid crystal capacitors respectively between the common electrode and each of the first and second pixel-electrodes, PEa and PEb. While a common voltage, Vcom is applied to the common electrode, other voltages may be respectively applied to the first and second pixel-electrodes, PEa and PEb so as to thereby define various different configurations of equipotential lines extending through the pixel unit. In the case where voltages respectively above and below Vcom (or vise versa) are applied respectively to the first and second pixel-electrodes, PEa and PEb, an equipotential line or curve corresponding to the Vcom voltage will be formed somewhere (e.g., midway) between the first and second pixel-electrodes, PEa and PEb. In one embodiment, liquid crystals positioned along the Vcom equipotential line align substantially vertically relative to the major surfaces of the first and second substrates.

In one embodiment, the respective first/second switching device Qa/Qb is each a three-terminal device such as a thin-film transistor (TFT) integrally provided in the lower panel 100. A control terminal thereof is connected to the gate line Gi, an input terminal thereof (source) is connected to the data line Dⱼ/Dⱼ₊₁, and an output terminal thereof (drain) is connected to the respective pixel-electrode, where pairs of the latter form the first liquid crystal capacitor Clc and optionally the first and second storage capacitors Csta and Cstb.

Referring to FIG. 2 and FIG. 3, the first liquid crystal capacitor Clc adopts the first pixel electrode PEa and the second pixel electrode PEb of a corresponding pixel unit as two terminals or plates thereof, and the liquid crystal layer 3 between the first and second pixel electrodes PEa and PEb and also between the lower and upper panels, 100 and 200 serves as a dielectric material.

The first pixel electrode PEa is connected to the first switching element Qa and the second pixel electrode PEb is connected to the second switching element Qb.

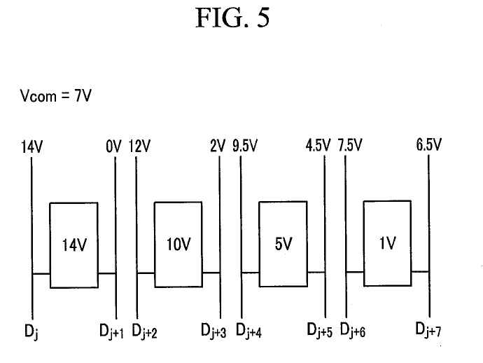

Alternative to FIG. 2, the second pixel electrode PEb may be provided on the upper panel 200. In one embodiment, the second pixel electrode PEb is not connected to a switching element when disposed in the upper panel 200 and instead receives the common voltage Vcom. In yet another embodiment, a separate common electrode is formed on the upper panel 200 and connected to receive the Vcom voltage while the first and second pixel electrodes, PEa and PEb are provided in spaced apart relation on the lower panel 100 and connected to receive voltages that are respectively higher and lower (or vise versa) than Vcom. In one embodiment, the higher and lower voltages are equidistant from Vcom (i.e., as shown in the case of FIG. 5 where Vcom=7V).

The liquid crystal layer 3 has dielectric anisotropy, and liquid crystal molecules of the liquid crystal layer 3 have their long axes aligned to be vertical to surfaces of the two panels 100 and 200 when an electric field is not locally present or when the net local electric field is essentially zero relative to Vcom.

Field forming capacitances including the first and second pixel electrodes PEa and PEb, and optionally the common electrode (not shown), may be formed in different layers or in the same layer. The first and second storage capacitors Csta and Cstb may serve as charge storage assistants of the first liquid crystal capacitor Clc and they may be formed by superimposing separate electrodes (not shown) provided on the lower panel 100 with being interposed between the first and second pixel electrodes PEa and PEb, and insulators.

Meanwhile, in order to implement color display, perception of a desired color may be provided by a spatial or temporal sum of primary colors by allowing pixel units PX to uniquely display one of the primary colors (spatial division) or the pixels PX to alternately display the primary colors (temporal division).

The primary colors may include three primary colors such as red (R), green (G), and blue (B) so as to substantially cover the color gamut typically perceived by the human visual system.

FIG. 2 shows that each pixel unit PX includes a respective color filter CF displaying one of the primary colors in an area of the upper panel 200 corresponding to the first and second pixel electrodes PEa and PEb as one example of the spatial division. In one embodiment, CF also corresponds to a portion of the common electrode provided in the upper panel if the common electrode is provided.

Alternatively to FIG. 2, the color filter CF may be disposed above or below the first and second pixel electrodes PEa and PEb of the lower panel 100.

At least one polarizer (not shown) is provided in the liquid crystal panel assembly 300 for polarizing light one way or another, where the liquid crystal material can further polarize selectively in the same or other ways so as to thereby form a variable light transmission valve.

Referring back to FIG. 1, the gray voltage generator 800 generates all gray voltages or gray voltages of a limited number (hereinafter referred to as “reference gray voltages”) related to the discrete brightness transmittance levels of the pixel PX.

The reference gray voltages may include a gray voltage having a positive value and another gray voltage having a negative value with respect to the common voltage Vcom and polarity reversal may be periodically implemented. In one embodiment, the provided discrete levels of gray voltage include pairs that are equidistant from Vcom with one of the pair being greater than Vcom and the other being lower.

The gate driver 400 is connected to the gate lines of the liquid crystal panel assembly 300, and applies a gate signal having a waveform configured of a combination of a gate-on voltage Von and a gate-off voltage Voff to the gate lines.

The data driver 500 is connected to the data lines of the liquid crystal panel assembly 300, and selects a gray voltage applied from the gray voltage generator 800 and applies the selected gray voltage as a data voltage to the data line.

However, in a case in which the gray voltage generator 800 provides reference gray voltages of a limited number instead of all the gray voltages, the data driver 500 may generate desired data voltages by dividing (extrapolating among) the reference gray voltages.

The signal controller 600 controls the gate driver 400 and the data driver 500.

Each of the drivers 400, 500, 600, and 800 is mounted directly on the liquid crystal panel assembly in the form of at least one monolithic integrated circuit (IC) chip, or is mounted as such on a flexible printed circuit film (not shown) to be attached onto the liquid crystal panel assembly 300 in the form of a tape carrier package (TCP), or is mounted as such on a separate printed circuit board (PCB) (not shown).

Alternatively, the driver circuits 400, 500, 600, and 800 may be integrated on the liquid crystal panel assembly 300 with signal lines and thin-film transistor switching elements.

Further, the drivers 400, 500, 600, and 800 may be integrated in the form of a single chip. In this case, at least one of them or at least one circuit element constituting them may be positioned outside the single chip.

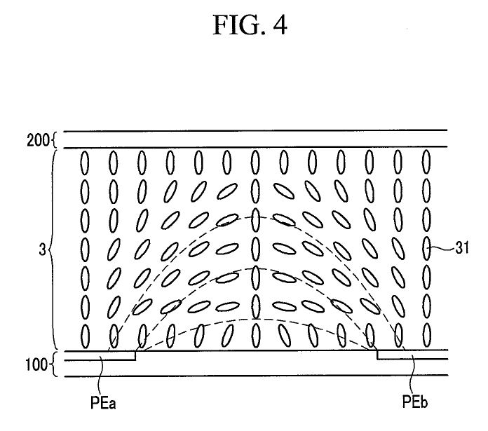

Hereinafter, referring to FIG. 4 and FIG. 5, and FIG. 1 to FIG. 3, an example of a driving method of a liquid crystal display device according to an embodiment will be described in detail.

FIG. 4 is a schematic cross-sectional view of a liquid crystal display device according to an exemplary embodiment of the present disclosure, and FIG. 5 is a diagram illustrating voltages simultaneously applied to paired data lines and interposed pixel units of a liquid crystal display device according to an embodiment.

First, referring to FIG. 1, the signal controller 600 receives input image signals R, G, and B and input control signals controlling display of the input image signals R, G, and B from an external graphics controller (not shown).

The input image signals R, G, and B contain luminance information of each pixel, and the luminance has a predetermined number of discrete gray levels, for example 1024 (=2¹⁰), 256 (=2⁸), or 64 (=2⁶), of grays.

The input control signals may include a vertical synchronization signal (Vsync), a horizontal synchronization signal (Hsync), a main clock signal (MCLK), a data enable signal (DE), and the like.

The signal controller 600 appropriately processes the input image signals R, G, and B according to an operating condition of the liquid crystal panel assembly 300 on the basis of the input image signals R, G, and B and the input control signals. The signal controller 600 generates a gate control signal CONT1 and a data control signal CONT2, and outputs the gate control signal CONT1 to the gate driver 400 and outputs the data control signal CONT2 and processed image signals DAT to the data driver 500.

According to the data control signal from the signal controller 600, the data driver 500 receives digital image signals DAT for a pixel of one row and converts each digital image signal DAT into an analog data voltage by selecting a gray voltage corresponding to each digital image signal DAT, and then applies the analog data voltages to the corresponding data lines.

The gate driver 400 applies the gate-on voltage Von to the gate line Gᵢ according to the gate control signal CONT1 from the signal controller 600 to turn on the first and second switching elements Qa and Qb connected to the gate line Gi.

Then, the data voltages applied to the data lines Dⱼ and Dⱼ₊₁ are applied to the corresponding pixel electrodes (PEa, PEb) through the corresponding first and second switching elements Qa and Qb.

That is, the data voltage then present on the first data line Dⱼ is applied to the first pixel electrode PEa through the turned-on first switching element Qa, and the data voltage then present on the second data line Dⱼ₊₁ is applied to the second pixel electrode PEb through the turned-on second switching element Qb.

At this time, the data voltages applied to the first and second pixel electrodes PEa and PEb are data voltages corresponding to a luminance to be displayed by the respective pixel unit PX, and in one embodiment, the PEa and PEb voltages have polarities opposite to each other with respect to the common voltage Vcom so that an equipotential line having a voltage corresponding to Vcom forms between the first and second pixel-electrodes, PEa and PEb.

A difference between the two data voltages which are applied to the first and second pixel electrodes PEa and PEb, defines a charging voltage that is stored by the liquid crystal capacitor Clc, that is, a respective first pixel voltage of the respective pixel unit PX.

When a potential difference is generated between the plates, PEa and PEb, of the first liquid crystal capacitor Clc, a corresponding electric field extending parallel to the major surfaces of the panels 100 and 200 is generated in the liquid crystal layer 3 between the first and second pixel electrodes PEa and PEb, as shown for example in FIG. 4 and somewhere along that electric field line (e.g., midway) there will be a point whose potential substantially equals Vcom.

In a case in which liquid crystal molecules 31 have positive dielectric anisotropy, the liquid crystal molecules 31 are inclined so that their long axes are aligned to be somewhat parallel to the direction of the electric field (if the potential is different than Vcom) and the inclination degree depends on the amplitude of the pixel voltage relative to Vcom.

Such a liquid crystal layer 3 is sometimes referred to as one operating in an electrically-inducted optical compensation (EOC) mode.

The degree of variation of polarization of light passing through the liquid crystal layer 3 depends on the inclination degree of the liquid crystal molecules 31.

The variation of polarization is expressed by variation in transmittance of light through the polarizers, through which the pixel PX displays luminance indicated by the effective gray level of the image signal DAT.

By repeating such pixel-electrode charging operations each over one horizontal period (also referred to as “1H”, equal to one period of the horizontal synchronization signal (Hsync) and the data enable signal DE), where the gate-on signal Von is sequentially applied to all the gate lines and the corresponding data voltages are applied to all the pixels PX it is possible to thereby display an image of one frame.

After one frame is terminated, the next frame starts. A state of an inversion signal RVS applied to the data driver 500 is controlled so that the polarity of the data voltages applied to each pixel PX is reversed to be opposite to that of the previous frame (“frame inversion”).

At this time, the polarity of the data voltage on each data line may be periodically changed during one frame according to characteristics of the inversion signal RVS (for example, row inversion and dot inversion) or the polarities of the data voltages applied to one pixel row may be alternately different from each other (for example, column inversion and the dot inversion).

FIG. 5 is a diagram illustrating voltages applied to each of the data lines when Vcom equals +7V and effective charging voltages stored in the liquid crystal capacitors of four adjacent pixels are 14V, 10V, 5V, and 1V, respectively, and a minimum voltage and a maximum voltage which the liquid crystal display device can use are 0V and 14V, respectively, in the liquid crystal display device according to the illustrated embodiment.

Referring to FIG. 5, each pixel is connected to two data lines Dⱼ, Dⱼ₊₁/Dⱼ₊₂, Dⱼ₊₃/Dⱼ₊₄, Dⱼ₊₅/Dⱼ₊₆, Dⱼ₊₇. Different data voltages having different polarities with respect to the common voltage Vcom may be applied to the two data lines Dⱼ,Dⱼ₊₁/Dⱼ₊₂,Dⱼ₊₃/Dⱼ₊₄,Dⱼ₊₅/Dⱼ₊₆,Dⱼ₊₇ connected to one pixel. A difference between the two data lines is a pixel voltage in each pixel PX. For example, when the common voltage Vcom is 7V, the voltages 14V and 0V may be applied to the first and second data lines Dⱼ and Dⱼ₊₁ respectively with a target pixel voltage, 14V, of the first pixel, 12V and 2V may be applied to the third and fourth data lines Dⱼ₊₂ and Dⱼ₊₃ respectively with a target pixel voltage, 5V, of the second pixel, 9.5V and 4.5V may be applied to the fifth and sixth data lines Dⱼ₊₄ and Dⱼ₊₅ respectively with a target pixel voltage, 5V, of the third pixel, and 7.5V and 6.5V may be applied to the seventh and eighth data lines Dⱼ₊₆ and Dⱼ₊₇ respectively with a target pixel voltage, 1V, of the fourth pixel. Note in this case that the applied pairs of data line voltages are equidistant relative to Vcom. That is for example, 12V is 5V greater than Vcom and 2V is 5V less than Vcom for the case of the illustrated second pixel unit.

As described above, by applying two data voltages having different relative polarities with respect to the common voltage Vcom (one higher, one lower than Vcom) to one pixel PX, the maximum driving voltage may be increased, the response speed of the liquid crystal molecules may be improved, and the transmittance of the liquid crystal display device may be improved. Further, since the two data voltages applied to the one pixel PX have relative polarities that are opposite to each other (relative to Vcom), it is possible to prevent deterioration of image quality due to flickers even in a case where the inversion type in the data driver 500 is the column inversion or the row inversion advantageously like the dot inversion.

In addition, when the first and second switching elements Qa and Qb are turned off in one pixel, the voltages applied to the first and second pixel electrodes PEa and PEb change simultaneously by respective kickback voltages, whereby, due to the same directed change on both pixel-electrodes, there is little variation in the effective charging voltage stored by the liquid crystal capacitor of the pixel unit PX. Accordingly, it is possible to improve display characteristics of the liquid crystal display by eliminating or reducing the effect of kickback voltages.

Furthermore, in a case of using liquid crystal molecules 31 that strongly tend to align vertically relative to the horizontal major surfaces of the display panels 100 and 200 when an effective charging voltage of zero is stored by the liquid crystal capacitor Clc, it is possible to improve the contrast ratio of a liquid crystal display device and implement a good optical viewing angle. Since the liquid crystal molecules 31 having positive dielectric anisotropy have dielectric anisotropy that is larger and rotational viscosity that is lower compared to liquid crystal molecules 31 having negative dielectric anisotropy, it is possible to increase the response speed of the liquid crystal molecules 31, where the response is to changes in effective charging voltage stored by the liquid crystal capacitor Clc. Also, since the tilt directions of the liquid crystal molecules 31 are easily set to the direction of generated electric field(s) including those between and close to the first and second pixel electrodes, PEa and PEb; and also optionally those emerging substantially vertically from the optional common electrode, it is possible to acquire excellent display characteristics even when an external pressure is applied to the upper panel 200 where this external pressure might in other situations, scatter the alignment of the liquid crystal molecules due to its external influence.

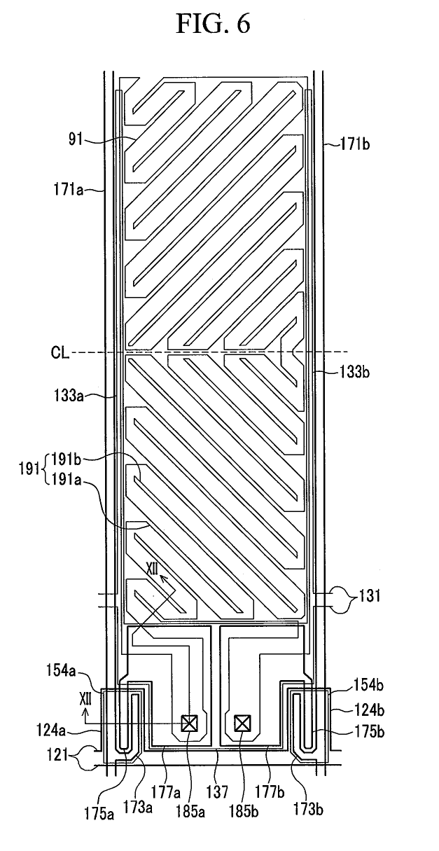

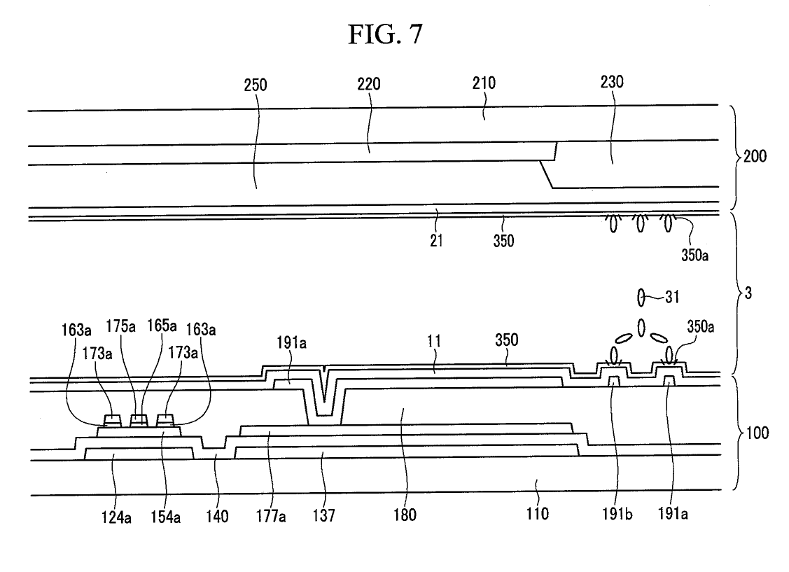

Hereinafter, referring to FIG. 6 and FIG. 7, an example of the liquid crystal panel assembly described above will be described in detail.

FIG. 6 is a layout view of a liquid crystal panel assembly according to an embodiment, and FIG. 7 is a cross-sectional view of the liquid crystal panel assembly taken along line XII-XII of FIG. 6.

Referring to FIG. 6 and FIG. 7, the liquid crystal panel assembly according to an embodiment includes a lower panel 100 and an upper panel 200, and a liquid crystal layer 3 interposed therebetween. It is understood that each of panels 100 and 200 includes a light-passing substrate such as one made of glass or plastic. Additionally for one embodiment the utilized glass or plastic is selected for good light transmission characteristics in the UV wavelength range as well as in the visible wavelength range.

First, the lower panel 100 will be described.

A plurality of gate conductors including a plurality of gate lines 121 and a plurality of storage electrode lines 131 are formed on a light-passing insulation substrate 110 of the lower panel 100.

The gate lines 121 transmit gate signals and extend mainly in a horizontal row direction of the panel. Each of the gate lines 121 includes plural pairs of first and second gate electrodes 124a and 124b projecting upward to define respective parts of the Qa and Qb transistors.

Each of the storage electrode lines 131 receives a predetermined voltage such as the common voltage Vcom, and each extends mainly in the horizontal direction. Each of the storage electrode lines 131 is positioned between two neighboring gate lines 121 and is closer to the gate line 121 positioned below the storage electrode line 131. Each storage electrode line 131 includes plural pairs of first and second storage electrodes 133a and 133b elongated vertically, and a storage extension part 137 having a relatively wide area. The first and second storage electrodes 133a and 133b are formed in a bar shape from the vicinity of the first and second gate electrodes 124a and 124b of the lower gate line 121 to the vicinity of the upper gate line 121. The storage extension part 137 has a substantially quadrangle shape in which two corners formed in a lower part of the storage extension part 137 are cut, and connects lower ends of the first and second storage electrodes 133a and 133b to each other. However, the shape and arrangement of the storage electrode line 131 including the storage electrodes 133a and 133b and the storage extension part 137 may be changed in various forms.

The gate conductors 121 and storage conductors 131 may have a single layered structure or a multilayered structure where each layer is composed of a different electrically conductive material.

A gate insulating layer 140 made of a silicon nitride (SiNx), a silicon oxide (SiOx), or the like (e.g., SiOxNy) is formed on the gate and storage conductors 121 and 131.

Plural pairs of first and second island-type semiconductors 154a and 154b made for example of hydrogenated amorphous silicon, polysilicon, or the like are formed on the gate insulating layer 140. The first and second semiconductors 154a and 154b are positioned above the first and second gate electrodes 124a and 124b, respectively.

A pair of island-type ohmic contact 163a and 165a are formed on each of the first semiconductors 154a, and a pair of island-type ohmic contact (not shown) are formed on each of the second semiconductors 154b. The ohmic contacts 163a and 165a may be made of a material such as n+hydrogenated amorphous silicon doped with n-type impurities at a high concentration, etc., or of silicide.

A data conductor including plural pairs of first and second data lines 171a and 171b and plural pairs of first and second drain electrodes 175a and 175b is formed on the ohmic contacts 163a and 165a and the gate insulating layer 140.

The first and second data lines 171a and 171b transmit the data signals and intersect the gate lines 121 and the storage electrode lines 131 while extending mainly in a vertical direction. The first and second data lines 171a and 171b include plural pairs of first and second source electrodes 173a and 173b bent in a U shape toward the first and second gate electrodes 124a and 124b to thereby define source electrode portions of the respective transistors Qa and Qb.

The first and second drain electrodes 175a and 175b include first and second extension parts 177a and 177b of which ends have a bar shape and a large area. The ends of the first and second drain electrodes 175a and 175b are partially surrounded by the first and second source electrodes 173a and 173b that are bent while facing each other around the first and second gate electrodes 124a and 124b. Outer contours of the first and second extension parts 177a and 177b are substantially similar to those of the storage extension part 137 positioned below the first and second extension parts 177a and 177b. The first extension part 177a overlaps the left half of the storage extension part 137, and the second extension part 177b overlaps the right half of the storage extension part 137.

The first/second gate electrode 124a/124b, the first/second source electrode 173a/173b, and the first/second drain electrodes 175a/175b respectively constitute the first/second thin film transistors Qa/Qb together with the first/second semiconductor 154a/154b. Channels of the first/second thin film transistor Qa/Qb are respectively formed in the first/second semiconductor 154a/154b between the first/second source electrode 173a/173b and the first/second drain electrode 175a 175b.

The data conductors 171a, 171b, 175a, and 175b may have a single layered structure or a multilayered structure (e.g. multiple metal or other conductor layers of different compositions).

The ohmic contacts 163a and 165a are formed between the semiconductors 154a and 154b and the corresponding data conductors 171a, 171b, 175a, and 175b that are disposed above the ohmic contacts 163a and 165a. The ohmic contacts 163a and 165a lower contact resistance between the semiconductors 154a and 154b and the data conductors 171a, 171b, 175a, and 175b. The semiconductors 154a and 154b are exposed between the source electrodes 173a and 173b and the drain electrodes 175a and 175b. In addition, the semiconductors 154a and 154b are exposed to the data conductors 171a, 171b, 175a, and 175b.

A passivation layer 180 that is may be made of an inorganic insulator, an organic insulator, or the like is formed on the data conductors 171a, 171b, 175a, and 175b and the exposed parts of the semiconductors 154a and 154b.

A plurality of contact holes 185a and 185b for exposing the first and second extension parts 177a and 177b are formed on the passivation layer 180.

A plurality of pixel electrodes 191 including plural pairs of first and second pixel electrodes 191a and 191b that are may be made of a transparent material such as indium tin oxide (ITO), indium zinc oxide (IZO), or the like, or a reflective metal such as aluminum, silver, chromium, or an alloy thereof, are formed on the passivation layer 180.

As shown in FIG. 6, the overall contour of the one pixel electrode 191 has an elongated quadrangular shape with internal finger extensions or branches in this embodiment. The finger portions of the first and second pixel electrodes 191a and 191b interdigitate with each other with a gap 91 therebetween. The first and second pixel electrodes 191a and 191b are generally vertically symmetrical with respect to a virtual horizontal center line CL and are divided into upper and lower regions.

The first pixel electrode 191a includes a lower projection portion, a left longitudinal stem portion, a horizontal stem portion extending to the right from a center of the longitudinal stem portion, and a plurality of branch portions. A branch portion positioned above the horizontal center line CL extends obliquely in an upper right direction from the longitudinal stem portion or the horizontal stem portion. The other branch portion positioned below the horizontal center line CL extends obliquely in a lower right direction from the longitudinal stem portion or the horizontal stem portion. An angle between the branch portions and the gate line 121 or the horizontal center line CL may be approximately 45 degrees.

The second pixel electrode 191b includes a lower projection portion, a right longitudinal stem portion, upper and lower horizontal stem portions, and a plurality of branch portions. The upper and lower horizontal stem portions extend horizontally to the left from a lower end and an upper end of the longitudinal stem portion, respectively. A branch portion positioned above the horizontal center line CL extends obliquely in a lower left direction from the longitudinal stem portion or the upper horizontal stem portion. The other branch portion positioned below the horizontal center line CL extends obliquely in an upper left direction from the longitudinal stem portion or the lower horizontal stem portion. An angle between the branch portions of the second pixel electrode 191b and the gate line 121 or the horizontal center line CL may also be approximately 45 degrees. The upper and lower branch portions may be at right angles to each other around the horizontal center line CL.

The branch portions of the first and second pixel electrodes 191a and 191b engage (interdigitate) with each other with a predetermined gap and are alternately disposed, thereby forming a pectinated pattern.

The respective first and second pixel electrodes 191a and 191b are physically and electrically connected to the first and second drain electrodes 175a and 175b through the contact holes 185a and 185b, respectively. The first and second pixel electrodes 191a and 191b receive respective data voltages from the first and second drain electrodes 175a and 175b. The first and second pixel electrodes 191a and 191b define the first liquid crystal capacitor Clc together with the liquid crystal layer 3. The first and second pixel electrodes 191a and 191b maintain the applied voltage due to their stored charges even after the first and second thin film transistors Qa and Qb are turned off.

The first and second extension parts 177a and 177b of the first and second drain electrode 175a and 175b connected to the first and second pixel electrodes 191a and 191b overlap the storage extension part 137 with the gate insulating layer 140 interposed therebetween, thereby constituting the first and second storage capacitors Csta and Cstb. The first and second storage capacitors Csta and Cstb strengthen the voltage storage capacitance of the first liquid crystal capacitor Clc.

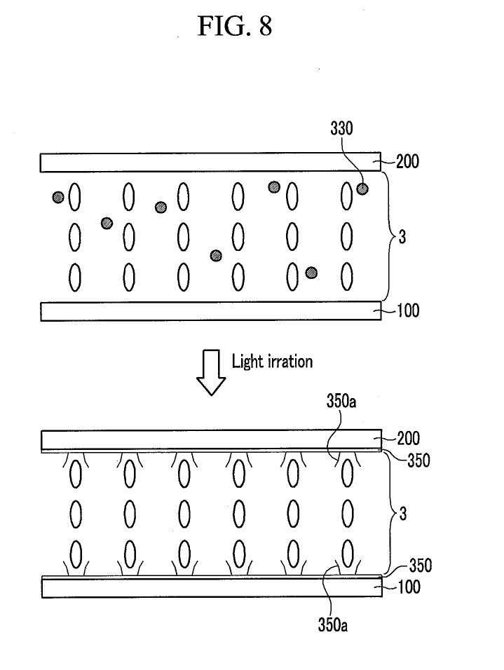

A liquid crystal molecules aligning layer 11 (alignment layer 11) is formed on inner surface of the lower panel 100. The alignment layer 11 may be a vertical alignment layer (in other words, one that tends to orient the longitudinal axes of adjacent liquid crystal molecules vertically relative to the exposed major surface of the alignment layer 11). A polymer layer 350 is formed on the alignment layer 11. The polymer layer 350 includes polymer branches or dangling bond portions 350a (see also FIG. 8) formed according to an initial arrangement direction of the liquid crystal molecules 31.

The polymer layer 350 can be formed by applying light, for example ultraviolet (“UV”), to a precursor or prepolymer moieties 330, for example a monomer, where the applied light induces polymerization of these prepolymer moieties 330 and partial attachment of the same to the alignment layer 11.

By applying the polymerizing light (e.g., UV) at the right time (e.g., when the adjacent liquid crystal molecules are oriented vertically relative to the exposed major surface of the alignment layer 11), the polymer layer 350 can be used to control the arrangement of the liquid crystal molecules according to the fixed orientations of the polymer branch 350a.

Next, the upper panel 200 will be described.

A light blocking member 220 is formed on an insulation substrate 210 made of transparent glass, plastic, or the like. The light blocking member 220 prevents light from being leaked between the pixel electrodes 191 and defines an opening region facing the pixel electrodes 191.

A plurality of colors filter 230 are each formed to extend under the insulation substrate 210 and partially under the light blocking member 220. Most of the color filters 230 exist within a region surrounded by the light blocking member 220. The color filters 230 may be elongated on a row of the pixel electrodes 191. Each of the color filters 230 may display one of primary colors including three primary colors such as red, green, and blue.

A light-passing planarizing overcoat 250 is formed on the color filters 230 and the light blocking member 220. The overcoat 250 may be made of an organic insulator. The overcoat 250 prevents the color filters 230 from being exposed and provides a flat surface. The overcoat 250 may be omitted if desired.

An alignment layer 21 is formed on inner surfaces of the lower panels 200. The alignment layer 21 may be a vertical alignment layer. A polymer layer 350 is formed on the alignment layer 21. The polymer layer 350 includes polymer branches 350a formed according to an initial arrangement direction of the liquid crystal molecules 31.

A polarizer (not shown) may be provided on outer surfaces of the panels 100 and 200. The liquid crystal layer 3 interposed between the lower panel 100 and the upper panel 200 has positive dielectric anisotropy. The liquid crystal molecules 31 may have their long axes aligned to be vertical to the surface of two panels 100 and 200 when no electric field is present or when the voltages on the first and second pixel-electrodes, PEa and PEb are substantially identical.

The polymer layer 350 formed on the inner surfaces of the two substrates 100 and 200 may reinforce interaction force of the alignment layers 11 and 21 and the liquid crystal 31. Also, the polymer layer 350 keeps the long axes of the liquid crystal molecules 31 aligned to be vertical to the surfaces of the two panels 100 and 200 in the condition of no electric field. The polymer branches 350a included in the polymer layer 350 and arranged by the side of the liquid crystal molecules 31 also reinforce interaction force of the alignment layers 11 and 21 and the liquid crystal 31.

When data voltages having different relative polarities (relative to Vcom) are later applied to the first and second pixel electrodes 191a and 191b, an electric field substantially parallel to the surfaces of the panels 100 and 200 is generated. The liquid crystal molecules of the liquid crystal layer 3, which are initially aligned to be vertical to the surfaces of the panels 100 and 200, respond to the horizontally oriented electric field extending between the first and second pixel-electrodes (PEa, PEb) and the long axes of the liquid crystal molecules accordingly come to be aligned roughly parallel to the extension direction of the induced electric field. A variation degree of polarization of light incident in the liquid crystal layer 3 is changed depending on the inclination degree of the liquid crystal molecules. The variation of the polarization is represented by variation of transmittance by the polarizers, whereby the liquid crystal display device displays an image.

In this way, it is possible to increase the contrast ratio of the liquid crystal display device and implement a wide viewing angle by using liquid crystal molecules 31 that are aligned vertically to the surfaces of the panels 100 and 200 when essentially no horizontally directed electric field is formed, but that tilt according to the induced and horizontally directed electric field. Also, it is possible to increase the driving voltage and improve response speed by applying two data voltages having different polarities with respect to the common voltage Vcom to one pixel unit PXᵢⱼ. Further, as described above, influences by the kickback voltage may be removed, thereby preventing flickering and the like.

According to an embodiment of the present disclosure, it is possible to secure a high contrast ratio and a wide light viewing angle of the liquid crystal display, and to increase the response speed of the liquid crystal molecules.

Since the liquid crystal molecules 31 having positive dielectric anisotropy have dielectric anisotropy that is larger and rotational viscosity that is lower compared to liquid crystal molecules 31 having negative dielectric anisotropy, it is possible to increase the response speed of the liquid crystal molecules 31.

Therefore, referring to FIG. 8, an example of the method of forming polymer layer 350 according to an embodiment will be described in more detail. FIG. 8 is a diagram illustrating mechanism of strongly vertically pre-orienting the liquid crystal molecules adjacent to that surface by curing the prepolymers by irradiating them with a polymerizing light such as ultraviolet (“UV”) on the display panel.

First of all, the liquid crystal molecules and the prepolymers 330 including polymers, oligomers, or monomers that can be cured by polymerization in response to exposure to a curing light, for example UV upon the prepolymers, are disposed between the first and the second substrates 100 and 200 during the manufacturing process.

The prepolymers to be cured by the polymerizing light, for example by UV, may include acryl, methacryl, dienyl, or vinyl groups. Thus the prepolymers may comprise acrylates, (meth)acrylates, compounds comprising polymerizable double bonds, vinyl groups, or the like, or a combination comprising at least one of the foregoing compounds. The prepolymers 330 may be reactive mesogen, for example benzoic diacylate.

In an embodiment, the prepolymers 330 may be contained in an amount between about 0.01 weight percent (wt %) to about 3 wt %, specifically between about 0.05 wt % to about 0.5 wt % of the pre-cured liquid provided between the first and the second substrates 100 and 200 during the manufacturing process.

While or shortly after applying an electric field to the liquid crystal layer such that that the liquid crystal molecules therein will align substantially vertically relative to the pixel-electrodes and to the common electrode (or in one case, not applying any electric field to get the same effect), the prepolymers 330 in the mixture are cured by shining a curing light upon the display panel. Then, since the liquid crystal molecules are pretilted in the desired orientation, the being-cured prepolymers 330 will orient themselves to comport with the alignment of the pretilted liquid crystal molecules. In one embodiment, as mentioned, the prepolymers 330 are cured by disposing light on the display panel under conditions in which the exposure voltage is not applied between the pixel electrode 140 and the common electrode 240, then, the liquid crystal molecules are vertically arranged due to their natural inclination to so align themselves. Of course, it is within the contemplation of the disclosure to form electric fields other than those that will pre-align the liquid crystal molecules essentially vertically to the major inner surfaces of the panels by applying various voltages to the first and second pixel-electrodes and/or to the common electrode (if present) and to cure the pre-polymers at the time of application of these voltages or shortly thereafter so as to obtain desired effects.

Since the liquid crystal molecules are pre-oriented in desired orientations prior to curing, therefore when the polymerizing light is irradiated on the display panel, the prepolymers 330 will be conformably polymerized according to the desired orientations. And then, the polymer layer 350 including the dangling polymer branches 350a on the inner surface of the two substrates 100 and 200 as shown FIG. 8 will be arranged according to the to-be-reinforced direction of the liquid crystal molecules.

In one embodiment, the energy levels of light irradiated onto the outside of one or both of the upper and lower panels may be between about 1 J to about 100 J, specifically between about 3 J to about 20 J per unit area. For example, in case of the prepolymer 330 being benzoic diacylate, the energy levels of light may be between about 1 J to about 15 J.

After the prepolymers 330 are so cured, the liquid crystal molecules 31 that are adjacent to the polymer layer will have an additional restoring force applied to them that restores the liquid crystal molecules 31 to initial arrangement in the condition of for example no horizontal electric field being applied. The additional restoring force is generated by the cured orientation of the polymer branches 350a. Namely, the liquid crystal molecules 31 of the liquid crystal layer 3 having their long axes aligned to be vertical to the surfaces of the two panels 100 and 200 will have the additional restoring force provided without aid of a vertical electric field by the orientation of the cured polymer branches 350a.

After applying a pre-orienting electric field to the liquid crystal layer, the prepolymers 330 may be cured by disposing light on the display panel, then, the liquid crystal molecules are naturally pretilted to the desired angles even without application of driving voltages to the pixel-electrodes. Then, the liquid crystal molecules 31 of the liquid crystal layer 3 having their long axes aligned to be vertical or tilt to the surfaces of the two panels 100 and 200 will have the additional restoring force without the electric field. The liquid crystal molecules 320 may be pretilted at a selected angle θ with respect to the perpendicular direction by controlling electric field applied to liquid crystal layer at the time or just prior to the time curing.

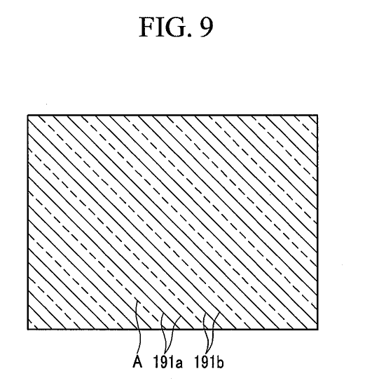

Next, referring to FIG. 9 to FIG. 11, another example of the function of the polymer layer 350 according to an embodiment will be described in detail.

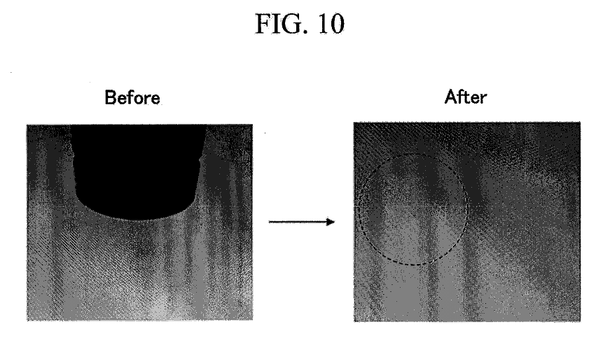

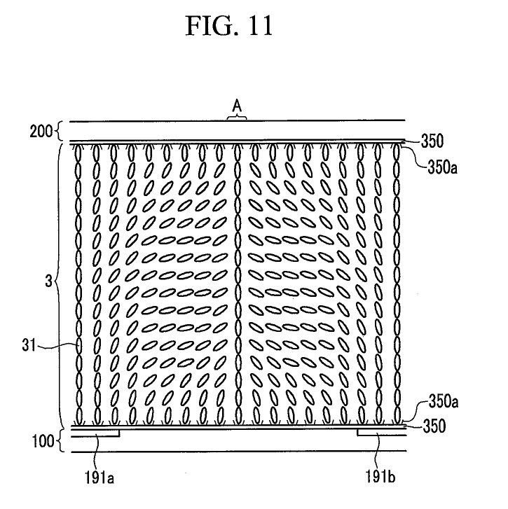

FIG. 9 is a diagram illustrating a uniform area of pixel electrode having backlighting shined through it and showing a resulting image texture region of a liquid crystal display device according to an embodiment formed as described above. FIG. 10 shows two photographs (before and after) of an experiment performed on such a pixel electrode and it shows a portion of the texture region of a liquid crystal display device manufactured according to the above (to include cured polymer branches 350a) where a stylus is intentionally pressed against the panel in the left photograph of FIG. 10, FIG. 11 is a schematic cross-sectional view of a liquid crystal display device showing the change in orientation that is believed to occur.

Since the liquid crystal molecules 31 of the liquid crystal layer 3 have their long axes naturally aligned to be vertical to the surfaces of the two panels 100 and 200 without the electric field thanks to the presence of the cured polymer branches 350a, when two data voltages having different polarities with respect to the common voltage Vcom are respectively applied to the first and second pixel electrodes 191a and 191b, a horizontal electric field is induced and the liquid crystal molecules 31 of the liquid crystal layer 3 which are close to the pixel electrodes are tilted to become more parallel to the panels 100 and 200 as shown in FIG. 11. However, the liquid crystal molecules 31 spaced roughly midway between at the same distance from the first and second pixel electrodes 191a and 191b may not be tilted to any one side because the effective potential field thereat matches Vcom and thus no net electric field is present and the liquid crystal molecules 31 thus maintain their initial orientation, that is vertical to the major surfaces of the panels 100 and 200. Then, a midway and consistent texturing region A having a lower luminance than the bordering areas thereof may be generated approximately midway between the two pixel electrodes 191a and 191b as is shown schematically in FIG. 9 and FIG. 11.

As shown in FIG. 10, the liquid crystal display device displays high-gray luminance such as white, the liquid crystal molecules 31 in the texture region between the two pixel electrodes 191a and 191b may be temporarily arranged horizontally to the display panels 100 and 200 when the liquid crystal molecules 31 receive disorienting pressure from the outside (by pressing the stylus against the upper panel). Parts of the texture region A where the liquid crystal molecules 31 were disturbed to become horizontally arranged may be recognized as yellowish bruising since the horizontally arranged liquid crystal molecules 31 contribute to the transmittance of the liquid crystal display. However, when a strong reorienting electric field is applied, the temporarily horizontally arranged liquid crystal molecules 31 in the texture region A return to their original vertical state due to application of the strong electric field in the liquid crystal layer 3 even though the pressure from the outside was applied. It is to be noted that bruising in conventional liquid crystal displays (LCDs) is not so easily removed, after the pressing item is removed even when time passes by.

However, as shown in FIG. 11, in an liquid crystal display device structured according to an embodiment of the present disclosure, the cured polymer layer 350 formed on the inner surfaces of the two substrates 100 and 200 appears to increase molecular interaction force between the alignment layers 11 and 21 and the liquid crystal molecules 31. Also, the cured polymer layer 350 works to keep their long axes of the liquid crystal molecules 31 aligned to be vertical to the surfaces of the two panels 100 and 200 even in the condition of no electric field so that the bruising repair function continues to operate even when the display device is powered down. Therefore, the temporarily horizontally re-arranged liquid crystal molecules 31 resulting in the textured region A can over time return back to their initial orientation because of the persistent restoring force applied by the cured polymer layer 350 which force works to persistently restore the liquid crystal molecules 31 to their initial manufactured arrangement. Accordingly, it is possible to more quickly remove display defects such as a yellowish bruising, etc. caused by application of external forces to the upper panel 200.

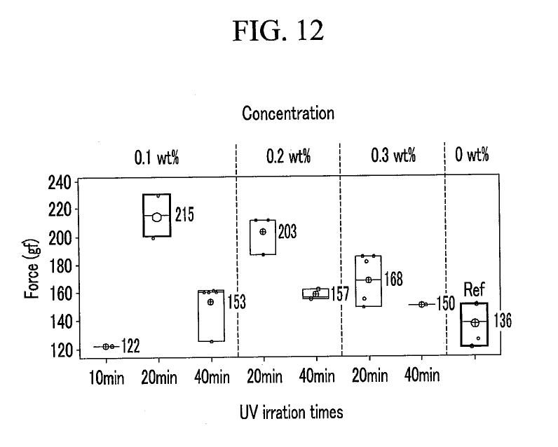

Hereinafter, referring to FIG. 12, an example of the liquid crystal display device that displays defects such as a yellowish bruising in response to external pressing where such bruising is removed over time from will be described in detail. FIG. 12 is a graph illustrating restoring force of the liquid crystal molecules restoring to their initial arrangement by a formed polymer layer according to an embodiment of the present disclosure. In the experiment, the restoring force of restoring the liquid crystal molecules 31 from their horizontal alignment to their initial vertical alignment to surfaces of the two panels 100 and 200 with no polymer layer (Ref) and polymer layer 350 formed in various conditions on the inner surfaces of the two substrates 100 and 200 are compared.

The energy intensity of exposed light was 6 mW, then, the exposed energy intensity (J=Ws) is

J(6 Ws)=energy intensity (0.006 W)*time (1000 s).

In an embodiment of the experiment, the restoring force restoring the liquid crystal molecules 31 to their initial vertical alignment to surfaces of the two panels 100 and 200 was measured in each case of no polymer layer (Ref) being included in the inner surfaces of the two substrates 100 and 200 versus cases where the polymer layer 350 was formed and cured in various conditions, for example variations of the prepolymer concentrations (measured in wt %) or light irradiation times, on the inner surfaces of the two substrates 100 and 200.

Referring to FIG. 10, the restoring force of the liquid crystal molecules 31 with the polymer layer 350 is higher compared to the restoring force of the liquid crystal molecules 31 with no polymer layer 350 Ref, except for the case of about 0.1 wt % of the prepolymers with respect to the liquid crystal molecules 310 and the case of using under 10 minutes of the light irradiation times. For example, in a case of no polymer layer Ref (also denoted as 0 wt %) included in the inner surfaces of the substrate, the restoring force to restore the liquid crystal molecules to the initial arrangement is 136(gf) on the average. But, in a case of polymer layer included in the inner surfaces of the substrate and formed under conditions in which the prepolymers are contained in an amount about 0.1 wt % and the light is irradiated during about 20 minutes, the restoring force to restore the liquid crystal molecules to the initial arrangement is 215(gf) on the average, which is substantially higher than the 136(gf) amount seen for the 0 wt % reference case. The more the restoring force of the liquid crystal molecules 31 back restoring to their initial arrangement is high, the more quickly the long axis of the liquid crystal molecules 31 in the texture region A return back to their vertical arrangement with respect to the surface of the substrate, the more quickly the display defects such as yellowish bruising, etc, can be removed. Therefore, the texture region A such as yellowish bruising, etc, in the polymer layer 350 formed in various conditions was substantially more quickly removed compared to the reference case of no polymer layer (Ref) being included in the inner surfaces of the two substrates 100 and 200.

In specific exemplary embodiments, in all the case where the light is irradiated between about 10 minutes to about 40 minutes on the liquid crystal layer, that is, the energy levels of the light irradiated being between about 2.3 J to about 14.4 J, the restoring force to return back the liquid crystal molecules 31 to their initial arrangement is higher than no polymer layer (Ref) being included in the inner surfaces of the two substrates 100 and 200.

According to embodiments of the present disclosure, it is possible to secure a high contrast ratio and a wide light viewing angle of the liquid crystal display.

Also, it is possible to increase the driving voltage and improve response speed by applying two data voltages having different polarities with respect to the common voltage Vcom to one pixel unit PX. Further, as described above, influences by the kickback voltage may be removed, thereby preventing flickering and the like.

According to an embodiment of the present disclosure, it is possible to secure a high contrast ratio and a wide light viewing angle of the liquid crystal display, and to increase the response speed of the liquid crystal molecules.

Since the liquid crystal molecules 31 having positive dielectric anisotropy have dielectric anisotropy that is larger and rotational viscosity that is lower compared to liquid crystal molecules 31 having negative dielectric anisotropy, it is possible to increase the response speed of the liquid crystal molecules 31.

Although specific embodiments have been described in detail, it will be apparent that those skilled in the art, after reviewing this disclosure, can make various modifications and changes thereto without departing from the principles and spirit of the general disclosure.

While this disclosure has described what are presently considered to be practical embodiments, it is to be understood that the teachings of this disclosure are not limited to the disclosed embodiments, but, on the contrary, they are intended to cover various modifications and equivalent arrangements included within the spirit and scope of the disclosure.

What is claimed is:

1. A liquid crystal display device, comprising:
first and second substrates opposed to each other;
a liquid crystal layer including liquid crystal molecules interposed between the first and second substrates;
a gate line formed on the first substrate and transmitting a gate signal;
first and second data lines formed on the first substrate and respectively transmitting first and second data voltages having different levels;
a first switching element connected to the gate line and the first data line;
a second switching element connected to the gate line and the second data line;
first and second pixel electrodes that are connected to the first and second switching elements, respectively, and separated from each other; and
an alignment layer formed on the first and second pixel electrodes,
wherein the liquid crystal layer including a plurality of polymers pretilting the liquid crystal molecules near the alignment layer by interacting with the alignment layer, and
wherein the first and second pixel electrodes include a plurality of branch electrodes, and
the branch electrodes of the first pixel electrode and the branch electrodes of the second pixel electrode are alternately disposed.

2. The liquid crystal display device of claim 1, wherein the liquid crystal molecules are substantially vertically aligned to horizontal surfaces of the first and second substrates.

3. The liquid crystal display device of claim 2, wherein distances between adjacent branch electrodes of the first pixel electrode and the second pixel electrode are uniform with respect to their position.

4. The liquid crystal display device of claim 2, wherein polarities of the first and the second data voltages are opposite to each other.

5. The liquid crystal display device of claim 3, wherein the branch electrodes of the first and second pixel electrodes are obliquely inclined with respect to the gate line.

6. The liquid crystal display device of claim 5, wherein the first and second pixel electrodes are formed in a same layer.

7. The liquid crystal display device of claim 6, wherein further comprising a common electrode that is formed on the second substrate and applied with a common voltage.

8. The liquid crystal display device of claim 1, wherein distances between adjacent branch electrodes of the first pixel electrode and the second pixel electrode are uniform with respect to their position.

9. The liquid crystal display device of claim 8, wherein the branch electrodes of the first and second pixel electrodes are obliquely inclined with respect to the gate line.

10. A method of manufacturing a liquid crystal display device, comprising:
preparing first and second substrates opposed to each other;
forming a liquid crystal layer by interposing liquid crystal molecules containing a plurality of prepolymers between the first and second substrates;
forming a gate line on the first substrate and transmitting a gate signal;
forming first and second data lines on the first substrate and respectively transmitting first and second data voltages having different levels;
forming a first switching element connected to the gate line and the first data line;
forming a second switching element connected to the gate line and the second data line;
forming first and second pixel electrodes that are connected to the first and second switching elements, respectively, and separated from each other;
forming an alignment layer on the first and second pixel electrodes; and
forming a plurality of polymers pretilting the liquid crystal molecules near the alignment layer by interacting with the alignment layer,
wherein the first and second pixel electrodes include a plurality of branch electrodes, and
the branch electrodes of the first pixel electrode and the branch electrodes of the second pixel electrode are alternately disposed.

11. The method of claim 10, wherein the liquid crystal molecules are substantially vertically aligned to horizontal surfaces of the first and second substrates.

12. The method of claim 11, wherein the polymers are formed by irradiating light on the liquid crystal layer containing a plurality of the prepolymers cured by polymerization.

13. The method of claim 12, wherein energy levels of the light disposed on the liquid crystal layer are between about 3 joules (“J”) to about 20 J per unit area.

14. The method of claim 12, wherein distances between adjacent branch electrodes of the first pixel electrode and the second pixel electrode are uniform with respect to their position.

15. The method of claim 12, wherein polarities of the first and the second data voltages are opposite to each other.

16. The method of claim 12, wherein the branch electrodes of the first and second pixel electrodes are obliquely inclined with respect to the gate line.

17. The method of claim 12, wherein the first and second pixel electrodes are formed in a same layer.

18. The method of claim 12, wherein further comprising forming a common electrode that is formed on the second substrate and applied with a common voltage.

19. The method of claim 10, wherein the prepolymers are contained in the liquid crystal layer in an amount between about 0.01 weight percent (wt %) to about 3 weight percent (wt %) based on the liquid crystal molecules.

20. The method of claim 19, wherein the prepolymers are contained in the liquid crystal layer in an amount specifically between about 0.01 weight percent (wt %) to about 0.5 weight percent (wt %) based on the liquid crystal molecules.
